(19) United States
(12) Patent Application Publication
(10) Pub. No.: US 2006/0037544 A1
(43) Pub. Date: Feb. 23, 2006

(54) Package for storage and distribution of wild bird seed convertible to a disposable squirrel proof wild bird feeder

(76) Inventor: James A. Hunter, Roswell, GA (US)

Correspondence Address: James A. Hunter, 445 Saddle Creek Circle, Roswell, GA, 30076, US

(21) Appl. No.: 11/196,334

(22) Filed: Aug. 4, 2005

Related U.S. Application Data
(60) Provisional application No. 60/600,217, filed on Aug. 10, 2004.

(51) Int. Cl. A01K 39/00

(52) U.S. Cl. 119/65

(57) ABSTRACT

A flexible plastic container for shipment and distribution of wild bird seed. The outer wall of the container 18 to have a shape that allows the bird seed to flow by gravity to the lower extremity of the container. One or more feeder holes 15 located at a convenient distance above a folding perch 14. This perch to be attached to the outer wall of the container 18 so that it can be secured against the container for shipping and handling, and folded outward when ready for hanging. The container to be heat sealed 12 after filling and sealed by removable seals to close the feeder holes and to secure the perch 14 in the shipping position. The purpose is to provide the consumer with a convenient, economical, method of feeding wild birds. It also is a better way to insure that the birds receive feed that is clean and free of mold and decay. If hung properly it will not be attacked or destroyed by squirrels.

### CROSS REFERENCE TO RELATED APPLICATION

PPA 60/600217 Filing Date Aug. 10, 2004

### FEDERALLY SPONSORED RESEARCH

not applicable

### SEQUENCE LISTING OR PROGRAM

not applicable

### BACKGROUND OF INVENTION

1. Field of Invention

This invention relates to animal feeding or more specifically to feeding of wild birds.

2. Background of the Invention

Feeding wild birds is a fairly common practice in the suburbs of America and possibly in rural areas as well. Surveying homes in the more prosperous neighborhoods one finds almost one in four have one or more bird feeders. Many of these feeders go unattended for long periods. The owners purchased them to decorate the landscape, or just found that it was too much trouble to service them properly. Most feeders are architechtual structures with open feeding stations. They are subject to weather which causes rotting seed and mold. To feed wild birds properly, these feeders require frequent filling and cleaning.

Every grocery store, every hardware store, every major drug store, every pet store, and a few stores offering wild bird products exclusively offer wild bird seed packed in plastic bags. These bags are rectangular and are packed with various types of wild bird seed weighing from 2 to 50 pounds. The feed is usually offered to birds in bird feeders with open platforms or trays subject weather. The feed becomes moldy and the feeders require cleaning and filling frequently. Most feeders are not serviced regularly and are never cleaned.

Many earlier inventions used plastic bags for bird feeders in one fashion or another. Some requiring the plastic bags to be placed in holders with various methods for piercing the bags and allowing the seed to flow on to platforms or trays. Others offer plastic containers of porous material designed to attract a specific kind of bird. Another patent suggests a plastic bag to be pierced by pointed sticks to provide perches for the birds. This method was not attractive to buyers because it required a two part purchase and users did not understand how to pierce the container. Repeated use by birds loosened the perches which became unstable and caused unnecessary spillage. This was presented by Salick in U.S. Pat. No. 4,026,244 issued May 31, 1977. This patent provided a fixed perch bar for closing the lower end of the plastic container and pointed sticks to be used to pierce the bag near the feeding holes. This product was unsuitable for shipment and storage because of the open, unsealed top, a plurality of parts and a fixed perch which would damage any adjacent products in storage or transit.

Pat. No. 5,740,758 in the name of Damm dated Apr. 21, 1998 may or may not remain in force. This patent claims a disposable bird feeder fabricated of porous sheet material with pores for dispensing seed especially for finches. The fabric would have from 80 to 120 pores per square inch. This feature would be eliminated in the proposed patent along with several other claims.

The following prior art patents were reviewed and in no instance were they found to conflict with the claims of this patent application.

| Patent number | Date | Name |
|---|---|---|
| 3,359,650 | September 1968 | Goodman |
| 4,026,244 | May 1977 | Salick |
| 1,618,324 | February 1927 | Burt |
| 1,895,69 | January 1933 | York |
| 3,179,244 | April 1965 | Kuhn |
| 3,568,641 | March 1971 | Kilham |
| 1,891,042 | December 1932 | Benoit |
| 2,306,312 | December 1942 | Hyde |
| D,251,021 | February 1979 | Blosbalg |
| 2,944,516 | July 1960 | Malloy Sr. |
| 3,083,687 | April 1963 | Slaven |
| 3,977,363 | August 1976 | Fisher Jr. |
| 4,233,941 | November 1980 | Webster |

### BACKGROUND OF INVENTION—OBJECTS AND ADVANTAGES

For those who are interested in feeding birds because they enjoy watching them and for those who want to help birds survive and multiply, this invention offers an easy convenient, and economical means to accomplish their objectives. Producing and filling the package is a simple and economical process. The package is sealed until ready for use, protecting the contents from damage or deterioration in storage and distribution. The key to this is the folding perch which remains flat against the container until unfolded, Prior to conversion the perch is held in place by a removable tacky label that also covers another label that closes the feeding hole or holes. These two labels keep the container air tight and streamlined for convenient handling.

The folding perch which allows the container to be stored, shipped and handled with no appendages or projections to puncture or otherwise snag or damage adjacent materials is the most unique and unobvious feature of this package. This is especially true in light of the necessity of providing a method of construction that provides mounting a perch that is retractable and yet is stable and stout enough to support good sized birds. Flexible plastic bags are less expensive than heavier more solid plastic containers. Mounting strong stable perches is more difficult on flexible packaging. The method used for this package depends on using the contents of the package to provide stability to the folding perch. After many attempts this was finally accomplished by using a thin metal perch just wide enough for birds feet and long enough for both small and larger birds. The perch was folded in half One half penetrated the opening at the extreme lower end of the package. The portion of the perch inside of the package was then surrounded by the bird seed and thereby made stable. The same result was obtained by attaching the portion of the perch formerly surrounded by the contents of the container to the outer wall of of the lower portion of the container. When birds light on the perch in this position, leverage is placed on the half of the perch attached to the opposite side of the container. The pressure against the opposite side of the container places pressure against the contents of the container. This lends stability to the perch. Although the first method of attaching the perch proved to be satisfactory, it required stapling as heat sealing or gluing was more difficult. The second method is easier to fabricate and more economical to produce. Economy is very important in marketing a disposable product The claims of this patent application are based on the latter mentioned construction.

The perch is folded snugly against the side of the container on which the feeding hole is located during storage and shipment. It is secured by a removable label which in turn secures another removable label that closes the feeding hole. The perch can be made of metal or plastic provided the perch can be folded or bent several times without fracturing or breaking.

An unexpected advantage of this package is the inability of squirrels to access the feed or damage the package, The construction of the perch and the method of hanging are very important. The perch must be strong enough to support perch feeding birds but too flexible to allow support for larger, heavier, acrobatic squirrels. A perch made from 26 gage aluminum sheet cut about one half inch wide and 12 inches long folded in half exhibits these properties. Any metal or other materials with the same properties would work just as well. If the package is hung with a vertical wire at least two feet long and is not close to any other limbs or structures it will be safe from squirrels. Squirrels can hang from horizontal wires but cannot hang from vertical wire. They are also unable to cling to the slick plastic package unless they are supported by a strong lengthy perch.

Since the package is made of flexible plastic and the sides are vertical, rain and moisture do not present a problem. The contents of the package are essentially sealed until taken by the birds.

### SUMMARY

The product of this patent application is simple, easy to produce, and inexpensive. It provides a new and novel method of marketing and distribution. It offers convenience and pleasure to the final user and provides benefits to wildlife. When hung near an often used window it allows a very close up view of the wild birds. Since it is inexpensive the container can be thrown away when the birds have eaten the contents and replaced with another purchase.

Although the flexible plastic bag is not as attractive as many fancy bird feeders, the package can be decorated with colorful printing using pictures of birds, flowers or vines. The printing must conform to labeling requirements, and must provide visibility of the contents in order to attract the birds. A tubular shaped container is probably the most practical, but other shapes can be produced so long as they allow gravity flow of the contents to the feeder holes.

### DRAWINGS—FIGURES

FIG. 1 presents an exploded view of the side of the package with a hanging slot 12 in the upper section and the outer wall of the container 18. The lower section is a side view of the plastic container showing the folded position of perch 14 the location of the feeder hole 15 and the outer wall of the container 18.

FIG. 2 Provides an exploded view of the back side of the package, which is the side opposite from the feeder hole 15. The upper section showing the heat seal 13 and the slot for hanging 12 and the outer wall of the container 18. The lower section provides a view of the folded perch 14 partially covering the feeder hole 15 and the outer wall of the of the container 18.

FIG. 3 is a frontal view of the lower portion of the package showing the feeder hole 15, the removable seal closing the feeder hole 17, the folded perch 14, the removable seal securing the perch 16 and the outer wall of the container 18

FIG. 4 presents a side view of the lower portion of the package with the perch 14 in the open position, the feeder hole 15 and the outer wall of the container 18.

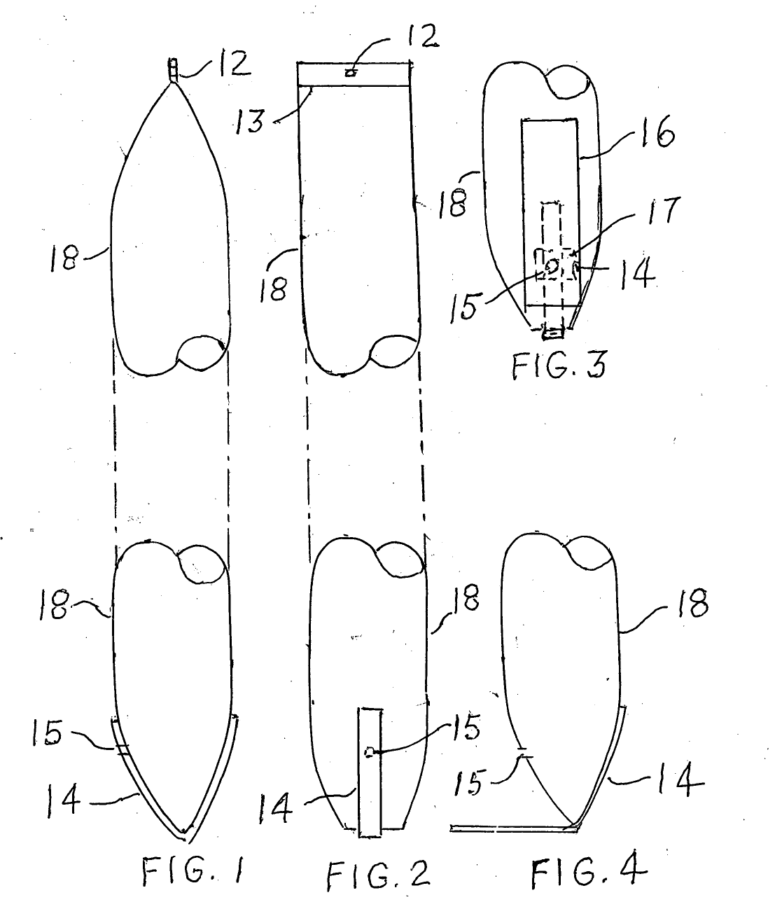

### DRAWINGS—REFERENCE NUMERALS

12 Slot for hanging
13 Heat seal
14 Perch
15 Feeder hole
16 Removable seal securing the perch.
17 Removable seal closing the feeder hole.
18 Outer wall of the container.

I claim:

1. A disposable wild bird feeder composed of:
a package shaped in an elongated contour that will provide a container allowing the contents to gravity flow to the lower extremity of said container, the outer wail of the container to be made of translucent or transparent plastic, the container to be heat sealed at its lower extremity to provide a cavity for the contents, a slot for hanging or supporting said package located in the upper part of the container, the container to be heat sealed below said slot for hanging, a feeder hole provided in one side of the lower portion of the container, a perch attached to the lower part of the container.

2. The disposable wild bird feeder of claim 1 wherein said feeder hole in the lower portion of the container has a removable label closing the feeder hole during filling, storage and distribution.

3. The disposable wild bird feeder of claim 1 wherein said perch is fabricated of thin metal or plastic with flat sides between ¼ and 2 inches wide that will conform to the shape of the outer walls of the container providing the package with the perch that can be folded and unfolded several times without breaking or fracturing.

4. The disposable wild bird feeder of claim 1 wherein the perch is folded in half, one half being long enough to be attached permanently to the outer wall of the lower portion of the container opposite from the outer wail containing the feeder hole, and the other half to be long and strong enough to support the birds that use the perch for reaching the wild bird seed.

5. The disposable wild bird feeder of claim 1 wherein the second half of the perch can be fitted snuggly against the lower portion of the outer wall of the container opposite the side to which the perch is permanently attached, with a removable label securing the perch in the folded position to provide a trim and smooth package that will not snag, tear or damage other packages or materials during storage and distribution and can be unfolded to a horizontal position after final placement.
